(19) United States
(12) Patent Application Publication
(10) Pub. No.: US 2026/0269756 A1
(43) Pub. Date: Sep. 10, 2026

(54) METHOD FOR CONTROLLING AN ELECTRICAL MACHINE, AND CONTROL SYSTEM

(71) Applicant: Rolls-Royce Deutschland Ltd & Co KG, Blankenfelde-Mahlow (DE)

(72) Inventors: Johannes Moritz MÜHLTHALER, Söchtenau (DE); Bastian Martin LEHNER, Altötting (DE)

(21) Appl. No.: 19/489,261

(22) PCT Filed: May 23, 2024
(86) PCT No.: PCT/EP2024/064232

§ 371 Date: Dec. 1, 2025

(30) Foreign Application Priority Data
Jun. 2, 2023 (DE) 10 2023 114 574.6

(51) Int. Cl. H02P 21/22; B64D 27/30; B64D 31/16

(52) U.S. Cl. CPC H02P 21/22; B64D 27/30; B64D 31/16

(57) ABSTRACT

A method for controlling a multi-phase electric machine with a stator and a rotor includes detecting a short circuit between turns of a winding of the multi-phase electric machine and at least one parameter describing the short circuit between turns. The method also includes setting an angle of a current vector to the positive q axis in the dq coordinate system of the rotor with a negative d portion and a q portion different than zero based on the at least one parameter describing the short circuit between turns, and controlling the multi-phase electric machine according to the set angle.

### PRIORITY

This application is the National Stage of International Application No.

PCT/EP2024/064232, filed May 23, 2024, which claims the benefit of German Patent Application No. DE 10 2023 114 574.6, filed Jun. 2, 2023. The entire contents of these documents are hereby incorporated herein by reference.

### BACKGROUND

Technical Field The present disclosure relates to a method for controlling an electric machine, to a control system, to an electric machine having such a control system, and to a computer-readable storage medium.

### Description of the Related Art

Vehicles (e.g., aircraft) are driven in a variety of configurations. Combustion engines (e.g., in the form of piston engines or gas turbine engines) make long ranges and high speeds possible. Meanwhile, drives having one or more electric motors enable the use of sustainably produced energy and are in some instances particularly low-maintenance and quiet. Advances in battery and fuel cell technology open up more and more fields of application of electric drives.

In the case of an electric motor of an electric drive, windings may be wound around teeth of a stator, for example. By applying a three-phase alternating voltage to the windings, magnetic fields that set a permanently excited rotor in motion relative to the stator, for example, are created. If, for example, a short circuit occurs within one of the windings between adjacent turns of the winding due to aging processes, vibrations, or external influences, very large electrical currents may be induced as a result of the rotation of the rotor by the magnetic fields of the rotating rotor in the short-circuited turn loop. These currents may lead to severe local heating and, in the worst case, thermal destruction of the electric motor. This is particularly relevant not only, but particularly, in aircraft in which, for example, permanently excited rotating field machines are used. Therefore, electric motors may be configured such that the electric motors may withstand a multiple of the heat load occurring in normal operation until the rotor stops, for example, as a result of a corresponding position of the rotor blades and/or a brake. Such measures in turn lead to a high weight and complex structure and thus to an increased energy requirement and a reduced range. In addition, the failure of an electric motor may mean a failure of a large portion of drive power, and therefore a larger number of electric motors may be provided (e.g., 4, 6, or 8 electric motors).

In “Detection and Compensation of Interturn Short Circuit in Interior Permanent Magnet Synchronous Machines Under Two-Level Voltage Source Inverter Limitations,” IEEE Transactions on Industry Applications, Vol. 58, No. 6, November/December 2022, P. C. Palavicino describes various points of the described problem and the setting of a d axis current to compensate the magnetic flux due to rotor rotation. The solution described therein is, however, only suitable for limited practical use.

### SUMMARY

The scope of the present disclosure is defined solely by the appended claims and is not affected to any degree by the statements within this summary.

The present embodiments may obviate one or more of the drawbacks or limitations in the related art. For example, the failure safety of an electric machine may be improved.

In a first aspect, a method for controlling a multi-phase (e.g. three-phase) electric machine with a stator and a rotor is provided. The method includes: Detecting a short circuit between turns of a winding of the electric machine and at least one parameter describing the short circuit between turns; setting an angle of the current vector (e.g., to the positive q axis) in the dq coordinate system of the rotor with a negative d portion and a q portion different than zero based on the at least one parameter describing the short circuit between turns; and controlling the electric machine according to the set angle of the current vector (e.g., to the positive q axis).

By dynamically adjusting the angle of the current vector to the positive q axis and thus the ratio of the d and q portions in the dq coordinate system of the rotor to the error that occurs, it is possible to minimize the remaining currents through the short-circuited conductor loop. As a result, the thermal load may be reduced even in the event of a short circuit. The electric machine, which is an electric motor, for example, may be set up particularly simply and with a reduced overall weight.

A multi-phase system is described by a number of n coordinates. For example, a three-phase system is described by three coordinates U, V and W, each offset by an angle of 120°. Currents flowing through the windings corresponding to these n (e.g. three) coordinates are 0 in total in a symmetrical multi-phase system (e.g. three-phase system). The dq coordinate system is rotated with the rotor using axes d and q at right angles to one another using a dq transformation. In this way, it is possible to describe the rotating field at a constant speed of rotation by the two time-constant variables d and q. The value d represents the magnetic flux density of the magnetic excitation in the rotor. The value q describes the torque generated by the rotor. Time changes (e.g., in the speed of rotation and/or in the torque) result in time changes in the d portion and/or q portion. One advantage of the dq transformation is that rotating field machines may be regulated using a PI regulator.

By setting the angle of the current vector to the positive q axis with a negative d portion, a magnetic flux generated by the excitation of the rotor is compensated. By setting a q portion different from zero, a torque may still be generated despite the short circuit.

In some embodiments, the angle of the current vector to the positive q axis may be set in a previously determined angle range (e.g., in the range from 30° to 85° or in the range from 40° to 80°). Depending on the application, the greatest reduction in the current in the short-circuited conductor loop is possible in the majority of cases of short circuits between turns in certain ranges that may be defined in advance in each case (e.g., in the ranges mentioned). For example, a negative q portion different than zero may be specified.

In some embodiments, the electric machine may include a plurality (e.g., 2, 3, or 4) of winding systems electrically isolated from one another (e.g., that may also be referred to as lanes). Each of the winding systems may in each case have windings for n (e.g., three) electrical phases. When the short circuit between turns is detected, it may be detected in that of the winding systems the short circuit between turns has occurred. When the electric machine is controlled, (e.g., only) the winding system with the short circuit between turns according to the set angle may be controlled. This allows the remaining winding systems to continue to be operated at full or near full power.

In some embodiments, the angle of the current vector to the positive q axis is optionally set based on electrical currents (and thus magnetic fields) of the winding systems in which the short circuit between turns has not occurred. Since the individual winding systems influence one another, the currents in the other winding systems may also induce the currents in the short-circuited conductor loop and vice versa. For example, the defective winding may have current supplied to it in such a way that the induction by the other winding systems is also at least partially compensated.

In some embodiments, the at least one parameter describing the short circuit between turns may include a characteristic (e.g., a location of the short circuit between turns within a winding, such as in the form of an identification, such as number, of a turn). A corresponding angle of the current vector to the positive q axis (or a dependence of the angle on one or more other parameters) may be stored for each possible location of a short circuit between turns. This is based on the recognition that the optimum angle of the current vector to the positive q axis may vary greatly for different locations. An individually optimized angle may be set for each possible location of the short circuit between turns.

In some embodiments, the characteristic (e.g., the location of the short circuit between turns) is determined by at least one sensor (e.g., by one or more Hall sensors, one or more coils, or the like). Operating parameters of an inverter supplying current to the winding may be evaluated.

In some embodiments, the angle of the current vector to the positive q axis may be set using a look-up table. This makes it easy and particularly quick to react.

In some embodiments, the at least one parameter describing the short circuit between turns may include a residual resistance of the short circuit between turns.

Depending on whether the short circuit has a resistance of almost 0 Ω or of 10 mΩ, for example, the optimum angle of the current vector to the positive q axis may vary greatly.

In some embodiments, in the step of setting the angle of the current vector to the positive q axis, a smaller angle is set for a larger residual resistance than for a smaller residual resistance. In this way, particularly suitable angles may be determined.

In some embodiments, the residual resistance of the short circuit between turns may be determined (e.g., measured) by at least one sensor. For example, voltages are measured at a plurality of points. A change in a voltage drop due to a short circuit between turns may be used to infer the residual resistance with a current known by the inverter.

In some embodiments, the method for controlling a multi-phase (e.g., three-phase) electric machine with a stator and a rotor is specified for flux compensation in the event of a short circuit between turns. The method may be performed according to any configuration described above. The method includes: detecting a short circuit between turns of a winding of the electric machine and at least one parameter describing the short circuit between turns; setting a negative d portion and/or a q portion different than zero in the dq coordinate system of the rotor based on the at least one parameter describing the short circuit between turns; and controlling the electric machine according to the set d and q portions in the dq coordinate system. In terms of the advantages, reference is made to the information above.

In a second aspect, a control system for controlling a multi-phase (e.g., three-phase) electric machine with a stator and a rotor is specified, where the control system is configured to carry out the method of any aspect described herein in any configuration described herein.

In a third aspect, an electric machine is provided. The electric machine includes the control system according to any configuration described herein. The electric machine also includes a stator and a rotor that is rotatable relative to the stator. The stator is arranged in a rotationally fixed manner with respect to a mount bearing the electric machine, for example.

In some embodiments, the electric machine may include a plurality of winding systems electrically isolated from one another, where each winding system of the plurality of winding systems in each case has windings for n (e.g., three) electrical phases.

In a fourth aspect, a vehicle (e.g., an aircraft) is provided, including the electric machine according to any configuration described herein (e.g., for driving a thrust-generating apparatus, such as a propeller). The vehicle (e.g., aircraft) includes a rotor unit that is able to be driven by the electric machine, for example. The advantages of the electric machine and the control system thereof described herein apply especially to a vehicle (e.g., to an aircraft).

In a fifth aspect, a computer-readable storage medium (e.g., a non-transitory computer-readable storage medium) is provided, including instructions that, when carried out by a processor arrangement (e.g. of the control system), cause the processor arrangement (and/or the control system) to perform the method of any aspect described herein in any configuration described herein.

### BRIEF DESCRIPTION OF THE DRAWINGS

The present disclosure will be explained in greater detail below using a plurality of example embodiments and with reference to the figures of the drawing, in which:

FIG. 1 shows an aircraft in the form of an airplane with an electric machine and a propeller driven thereby;

FIG. 2 shows a schematic sectional depiction of a basic design of a permanently excited, multi-phase, here by way of example three-phase, electric machine as an internal rotor;

FIG. 3 shows a dq diagram in which an example angle of the current vector to the positive q axis with a q portion different than zero is marked;

FIG. 4 shows a schematic sectional depiction of a tooth of a stator of the electric machine of FIG. 2 with a short circuit between two adjacent turns;

FIGS. 5 to 7 show diagrams in which relative currents are plotted based on a set angle of the current vector to the positive q axis in the event of the short circuit between turns of FIG. 4;

FIG. 8 shows a schematic sectional depiction of a tooth of a stator of the electric machine of FIG. 2 with a short circuit between two adjacent turns other than those in FIG. 4;

FIGS. 9 to 11 show diagrams in which relative currents are plotted based on a set angle of the current vector to the positive q axis in the event of the short circuit between turns of FIG. 8; and

FIG. 12 shows a method for controlling a multi-phase, here by way of example three-phase, electric machine.

### DETAILED DESCRIPTION

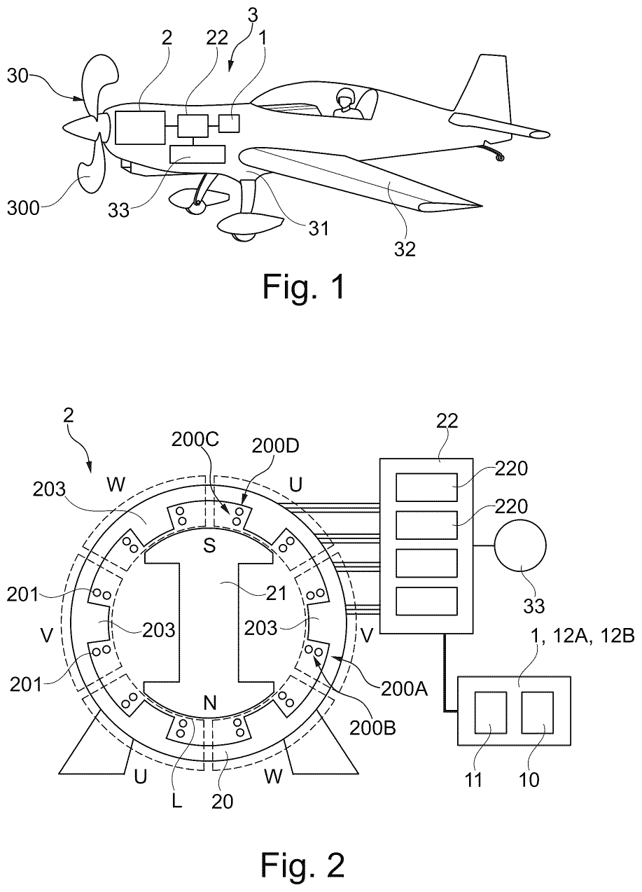

FIG. 1 shows an aircraft 3 in the form of an electrically driven airplane. The aircraft 3 includes a rotor unit 30 (e.g., in the form of a propeller) with a plurality of rotor blades 300 that is driven by an electric machine 2. The example aircraft 3 includes a fuselage 31 and wings 32.

The aircraft 3 includes an energy source (e.g., in the form of an electric battery system 33). Alternatively or in addition, the aircraft 3 may include a fuel cell and/or a generator. The electric machine 2 is supplied with energy by the energy source, where the energy source is electrically connected to an inverter system 22 that in turn provides the electrical energy to the electric machine.

The electric machine of the aircraft 3 includes a control system 1 that controls the inverter system 22 and thus the electric machine 2.

FIG. 2 shows a schematic sectional depiction of the rotating electric machine 2 of the aircraft 3. The electric machine 2 is in the form of a permanently excited synchronous machine, for example. The electric machine 2 in the present case is in the form of an internal rotor. The electric machine 2 includes a stator 20 that has an opening (e.g., a through-opening, which is not denoted), in which a rotor 21 is arranged in a rotatably mounted manner.

The stator 20 includes a body (e.g., in the form of a laminated core), on which teeth 203 are fixed. The teeth 203 may also be referred to as stator teeth. The teeth 203 are aligned with an air gap L between the body 10 of the stator 21 and the rotor 21. The teeth 203 protrude radially from the body (e.g., radially inward).

The stator 20 has a plurality of winding systems 200A-200D. The plurality of winding systems 200A-200D are electrically isolated from one another. Each winding system of the plurality of winding systems 200A-200D has windings 201 for three electrical phases U, V, W. The individual winding systems 200A-200D are only schematically illustrated here for a simplified depiction. Electrical conductors of the plurality of winding systems 200A-200D are wound around the teeth 203 of the stator 20 in the form of windings 201.

Each winding system of the plurality of winding systems 200A-200D is configured for three-phase operation (e.g., connected to a three-phase AC voltage with phases U, V, W). During operation of the electric machine 2 as intended, the AC voltage is applied to the plurality of winding systems 200A-200D as appropriate.

The rotor 21 is configured as a salient pole rotor by way of example, which includes permanent magnets for providing the magnetic flux. In the present configuration, it is provided that the rotor 21 has exactly one magnetic north pole N and one magnetic south pole S. In alternative configurations, there may be provision for more magnetic poles in alternation in the circumferential direction transverse to an axis of rotation of the rotor 21 (e.g., relative to the stator 20).

The rotor 21 is rotatably mounted. As a result of the three-phase AC voltage, the phases U, V, W of which are each phase-shifted by 120°, a magnetic rotating field is generated during operation as intended. The magnetic rotating field interacts with the permanently excited magnetic field provided by the rotor 21, such that a corresponding rotational movement of the rotor 21 in relation to the stator 20 may be brought about in a motor mode. In the present case, provision is made for the electric machine 2 to be used as a drive motor for a rotor unit 30 of the aircraft 3. The segments of the plurality of winding systems 200A-200D that are assigned to the respective phases U, V, W are depicted schematically in FIG. 2.

Each winding system of the plurality of winding systems 200A-200D of the electric machine 2 is connected to a three-phase inverter 220 of the inverter system 22. The respective inverter 220 provides the electrical AC voltage with the three phases U, V, W for the respective winding system 200A-200D. The inverters 220 derive the electrical energy required for operation as intended from the energy source connected to the inverter system 22 (e.g., in the form of the battery system 33). Each of the inverters 220 has inverter units assigned for the provision of the phases U, V, W. Each of the inverter units has a half-bridge circuit. The respective half-bridge circuit has a series circuit consisting of two electronic switching elements (e.g., transistors) that are connected to an intermediate circuit DC voltage of the inverter 220. The electronic switching elements are operated in a clock mode that provides clock patterns in the form of a PWM signal, for example. The corresponding phase U, V, W of the three-phase AC voltage is then available at a respective center tap of the half-bridge circuits. Appropriate filtering is carried out by the inductance of the windings 201, so that an appropriate alternating current is obtained for each of the phases U, V, W. The alternating current may be virtually sinusoidal if the inverter units are suitably controlled.

The individual inverters 220 are independent of one another. In the event of a failure of one of the winding systems 200A-200D or one of the inverters 220, the others of the inverters 200 and winding systems 200A-200D may continue to be operated.

The control system 1 is communicatively connected to the inverter system 22. The control system 1 regulates the inverters 220 of the inverter system 22. In the present case, the regulation is carried out in each case using the rotor-fixed dq coordinate system.

In a short circuit between turns, in which adjacent turns within a winding 201 are short-circuited together (e.g., as a result of defective insulation), a very large current may be induced in the short-circuited conductor loop even when the supply of current to the affected winding system 200A-200D is switched off by the rotor 21, which continues to rotate (e.g., at least for a certain period of time). This may lead to a high thermal load and consequential damage as a result. To compensate the magnetic flux caused by the rotor 21, the control system 1 is configured to detect a short circuit between turns of a winding 201 of the electric machine 2. The control system 1 is configured to detect at least one parameter describing the short circuit between turns. The control system 1 is configured to set a negative d portion and/or a q portion different than zero in the dq coordinate system of the rotor 21 based on the at least one parameter describing the short circuit between turns in response to the detection of the short circuit between turns. For example, the control system of the described example is configured to set an angle n of the current vector to the positive q axis in the dq coordinate system of the rotor 21 with a negative d portion and a q portion different from zero based on the at least one parameter describing the short circuit between turns. The control system 1 is configured to control the electric machine 2 (e.g., by regulating the inverters 220) according to the set angle n.

The magnetic flux caused by the rotating rotor 21 may be compensated, and therefore, only a significantly smaller current flows in the short-circuited conductor loop.

The control system includes a processor arrangement 11 and a storage medium 10 on which instructions are stored that, when they are carried out by the processor arrangement 11, cause the processor arrangement 11 and the control system 1 to perform a corresponding method.

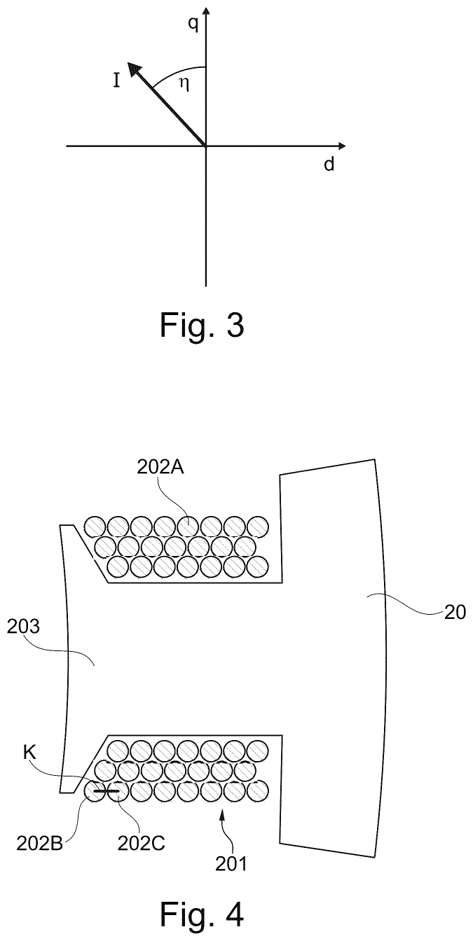

FIG. 3 illustrates the dq coordinate system. In the dq coordinate system, a current vector I that has both a positive q portion different than zero and a negative d portion different from zero is marked. The angle n that corresponds to the angle of current vector I to the positive q axis follows from the size of these two portions. The precise setting of this angle n of the current vector to the positive q axis for regulation of the inverters 220 allows for particularly effective flux compensation, as will be explained in more detail below.

FIG. 4 shows a segment of the stator 20 with one of the teeth 203. A winding 201 is wound around the tooth 203. The winding 201 includes, for example, only one conductor of one of the winding systems 200A-200D (e.g., specifically of one phase), but may also include conductors of a plurality of the winding systems 200A-200D. The winding 201 includes a number of turns, including a plurality of intact turns 202A. However, there is a short circuit between turns K between two further turns 202B, 202C. The turns 202B, 202C are short-circuited together due to the short circuit between turns K. As a result, there is a self-contained loop of the conductor forming the turns 202B, 202C.

In the example of FIG. 4, the short circuit between turns K is formed adjacent to an end of the tooth 203 facing the rotor 21.

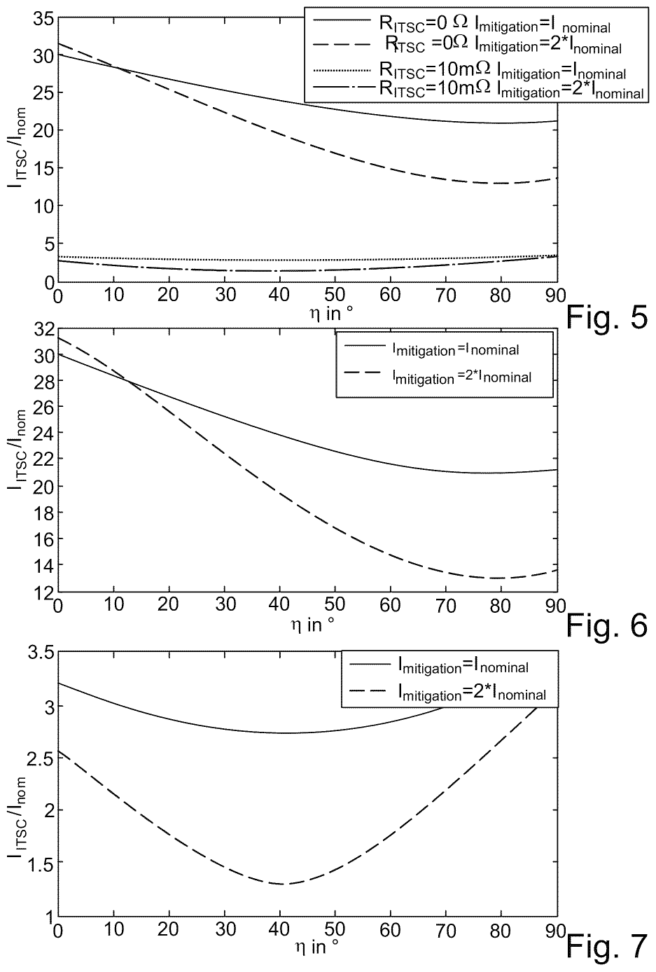

FIG. 5 shows the current inter-turn short circuit (IITSC) (e.g., normalized to the nominal current of the winding Inom during normal operation of the electric machine 2) induced as a result of the rotation of the rotor 21 in the short-circuited conductor loop against the angle n of the current vector to the positive q axis of 0 to 90 degrees. Here, FIG. 5 shows four different curves, of which the two upper ones are also depicted separately in FIG. 6 for improved representation, and the two lower ones are also shown separately in FIG. 7. All four curves are the result of simulations and illustrate the dependence of the optimum angle n on a parameter describing the short circuit between turns K, (e.g., the residual resistance of the short circuit between turns K).

The two upper curves shown in FIG. 5 and shown separately in FIG. 6 correspond to a perfect short circuit between turns K at the location illustrated in FIG. 4, which has a residual resistance of 0 Ω. The two lower curves shown separately in FIG. 7 correspond to a short circuit between turns K at the location illustrated in FIG. 4, which has a residual resistance of 10 mΩ. As expected, a lower residual resistance leads to a larger induced current IITSC, but the strong dependence of the induced currents IITSC on the angle η of the current vector to the positive q axis is noteworthy. All of the curves have a minimum at which the induced current IITSC is minimal at a corresponding angle η. This angle η corresponding to the minimum induced current IITSC may be referred to as the optimum angle η of the current vector to the positive q axis, because this enables the best reduction of the current in the short-circuited conductor loop. For the two upper curves in FIG. 5 (more easily seen in FIG. 6), the optimum angle η is in the region of 80°. In contrast, the optimum angle η is between 40° and 50° for the two lower curves in FIG. 5 (more easily seen in FIG. 7). Therefore, the control system 1 is configured to set a smaller angle η for a larger residual resistance than for a smaller residual resistance.

The uppermost curve in the region of 50° in FIG. 5 corresponds to a current I_{mitigation}, used to compensate the rotor flux, through the winding 203 with the short circuit between turns K with an absolute value equal to the nominal current. A greater reduction of the current in the short-circuited conductor loop allows for a larger current, as the second curve from the top in the region of 50° illustrates. This corresponds to a current I_{mitigation}, used to compensate the rotor flux, through the winding 203 with the short circuit between turns K with an absolute value of twice the nominal current. The two lower curves in FIG. 5 also each correspond to a current I_{mitigation}, used to compensate the rotor flux, through the winding 203 with the short circuit between turns K with an absolute value equal to the nominal current (above), and to a current I_{mitigation}, used to compensate the rotor flux, through the winding 203 with the short circuit between turns K with an absolute value of twice the nominal current (below).

By virtue of the residual resistance being measured by the control system 1 (e.g., by at least one sensor 12A, 12B) (see, e.g., FIG. 2, in the manner already described) and/or using operating data of the corresponding inverter 220, the optimum angle η of the current vector to the positive q axis may be determined and set using the known dependence thereon.

The current I_{mitigation} that may be used to compensate the rotor flux may also be used to determine the optimum angle η of the current vector to the positive part of the q axis. FIGS. 5 to 7 show four different possible cases merely by way of example. The control system 1 may store substantially more values for possible residual resistances and/or usable currents. Optionally, the control system 1 includes a look-up table in which the control system 1 specifies an optimum angle η for each set of values (e.g., residual resistance, usable current, and/or location). Optionally, the control system 1 may interpolate between the respective angles n at a present value lying between two values.

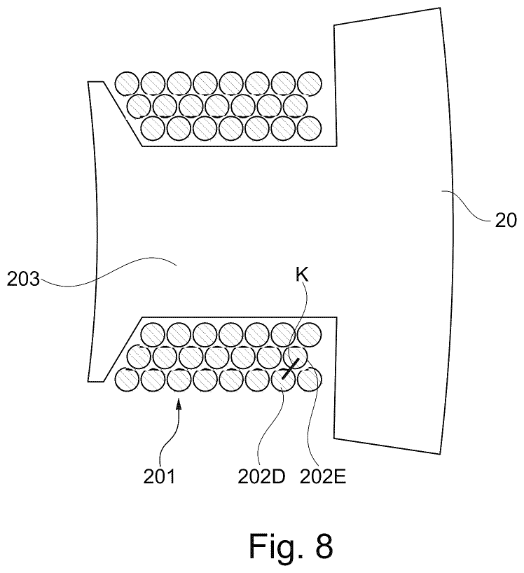

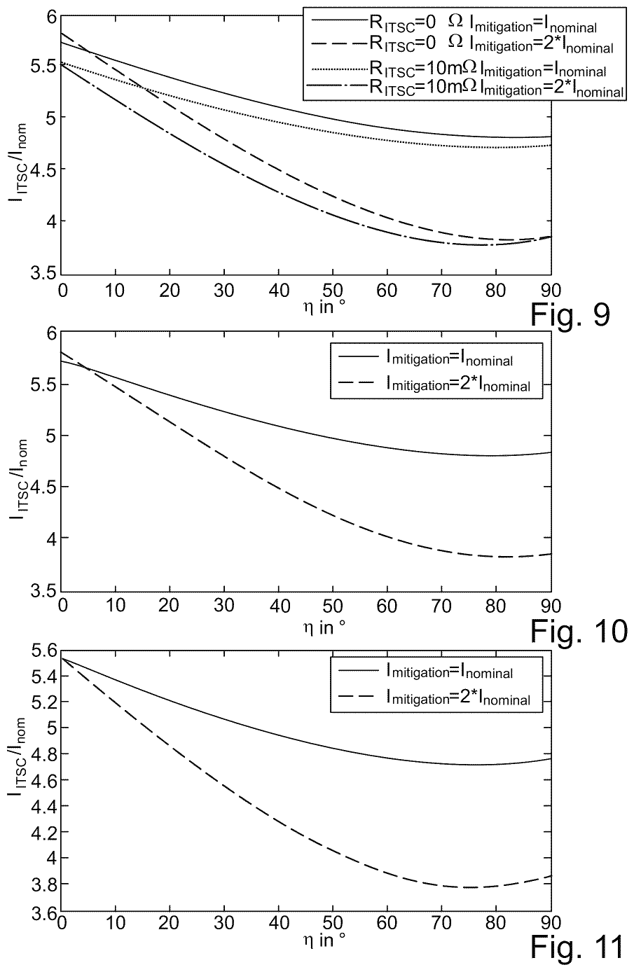

FIG. 8 shows the segment of the stator 20 of FIG. 4, but the short circuit between turns K has occurred at another location (e.g., between a turn 202D and a turn 202E). The turns 202D and 202E are arranged adjacent to an end of the tooth 203 facing away from the rotor 21. FIGS. 9 to 11 again correspond to FIGS. 5 to 7, and were calculated only for the location of FIG. 8. In the comparison of FIGS. 5 to 7 with FIGS. 9 to 11, substantial differences in the minima of the curves and the respective optimum angles n are apparent. These occur at higher values of the angle η here.

In the present case, the at least one parameter describing the short circuit between turns K also includes the location of the short circuit between turns K within the winding 201. The location of the short circuit between turns K will be determined, for example, by at least one sensor 12A, 12B (see, e.g., FIG. 2, in the manner already described) and/or using operating data of the corresponding inverter 220. After the location has been determined, the control system 1 may determine and set the optimum angle η for this location (and optionally the measured residual resistance and/or the determined current I_{mitigation} that may be used to compensate the rotor flux). The angle η is set, for example, in the range from 30° to 85° (e.g., in the range from 40° to 80°). The look-up table already mentioned may also include the location. Alternatively or in addition, the control system 1 may include a machine learning model. This may be trained with training data of FIGS. 5-7 and 9-11 and thus output the optimum angle η for input measured values (e.g., with respect to residual resistance and/or location). A stator flux may also be measured and minimized by regulation by the control system 1.

An angle η of the current vector to the positive q axis, optimized specifically for the error that has occurred, may be determined and set. Optionally, the angle η is dynamically adjusted (e.g., multiple times during flux compensation, continuously updated) since the residual resistance may change over time, for example. During detection of the short circuit between turns K, the control system 1 detects in which of the winding systems 200A-200D the short circuit between turns K has occurred. During control of the electric machine 2, the winding system 200A-200D is controlled with the short circuit between turns K according to the set angle η. Optionally, the angle η is set based on the electrical currents of the winding systems 200A-200D in which the short circuit between turns K has not occurred.

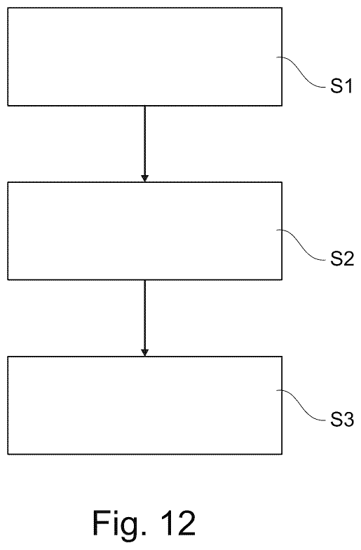

FIG. 12 shows a method for controlling a three-phase electric machine 2 with a stator 20 and a rotor 21, specifically for compensating a current induced in the event of a short circuit between turns. The method includes the following steps:

Step S1: Detecting a short circuit between turns K of a winding 201 of the electric machine 2 and at least one parameter describing the short circuit between turns K.

Step S2: Setting an angle η of the current vector to the positive q axis in the dq coordinate system of the rotor 21 with a negative d portion and a q portion different than zero based on the at least one parameter describing the short circuit between turns K, and/or setting S2 a negative d portion and/or a q portion different than zero in the dq coordinate system of the rotor 21 based on the at least one parameter describing the short circuit between turns K.

Step S3: Controlling the electric machine 2 according to the set angle η (and/or according to the set d portion and/or the set q portion in the dq coordinate system).

The described field-oriented regulation allows for particularly effective compensation of the induced current in the event of a fault and increased failure safety.

The disclosure is not limited to the embodiments described above, and different modifications and improvements may be made without deviating from the concepts described here. Any of the features may be used separately or in combination with any other features, unless they are mutually exclusive, and the disclosure extends to and includes all combinations and sub-combinations of one or more features that are described herein.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1.-16. (canceled)

17. A method for controlling a multi-phase electric machine with a stator and a rotor, the method comprising:
detecting a short circuit between turns of a winding of the multi-phase electric machine and at least one parameter describing the short circuit between turns;
setting an angle of a current vector to the positive q axis in the dq coordinate system of the rotor with a negative d portion and a q portion different than zero based on the at least one parameter describing the short circuit between turns; and
controlling the multi-phase electric machine according to the set angle,
wherein the multi-phase electric machine comprises a plurality of winding systems electrically isolated from one another, each winding system of the plurality of winding systems having windings for a plurality of, in particular three, electrical phases,
wherein detecting the short circuit between turns comprises detecting in which winding system of the plurality of winding systems the short circuit between turns has occurred, and
wherein controlling the multi-phase electric machine comprises controlling the winding system with the short circuit between turns according to the set angle.

18. The method of claim 17, wherein the angle is set in a predetermined range from 30° to 85°.

19. The method of claim 18, wherein the predetermined range is from 40° to 80°.

20. (canceled)

21. The method of claim 17, wherein the angle is set based on electrical currents of winding systems of the plurality of winding systems in which the short circuit between turns has not occurred.

22. The method of claim 17, wherein the at least one parameter describing the short circuit between turns comprises a location of the short circuit between turns within the winding.

23. The method of claim 17, further comprising determining, by at least one sensor, a characteristic of the short circuit between turns.

24. The method of claim 17, wherein the angle is set using a look-up table.

25. The method of claim 17, wherein the at least one parameter describing the short circuit between turns comprises a residual resistance of the short circuit between turns.

26. The method of claim 25, wherein setting the angle comprises setting a smaller angle for a larger residual resistance than for a smaller residual resistance.

27. The method of claim 26, further comprising measuring, by at least one sensor, the residual resistance of the short circuit between turns.

28. The method of claim 17, further comprising:
setting the negative d portion, the q portion, or the negative d portion and the q portion different than zero in the dq coordinate system of the rotor based on the at least one parameter describing the short circuit between turns; and
controlling the multi-phase electric machine according to the set d portion, the set q portion, or the set d portion and the set q portion in the dq coordinate system.

29. A control system for controlling a multi-phase electric machine with a stator and a rotor, the control system comprising:
a processor configured to:
detect a short circuit between turns of a winding of the multi-phase electric machine and at least one parameter describing the short circuit between turns;
set an angle of a current vector to the positive q axis in the dq coordinate system of the rotor with a negative d portion and a q portion different than zero based on the at least one parameter describing the short circuit between turns; and
control the multi-phase electric machine according to the set angle,
wherein the multi-phase electric machine comprises a plurality of winding systems electrically isolated from one another, each winding system of the plurality of winding systems having windings for a plurality of, in particular three, electrical phases,
wherein the detection of the short circuit between turns comprises detection of in which winding system of the plurality of winding systems the short circuit between turns has occurred, and
wherein the control of the multi-phase electric machine comprises control of the winding system with the short circuit between turns according to the set angle.

30. A non-transitory computer-readable storage medium that stores instructions executable by one or more processors to control a multi-phase electric machine with a stator and a rotor, the instructions comprising:
detecting a short circuit between turns of a winding of the multi-phase electric machine and at least one parameter describing the short circuit between turns;
setting an angle of a current vector to the positive q axis in the dq coordinate system of the rotor with a negative d portion and a q portion different than zero based on the at least one parameter describing the short circuit between turns; and
controlling the multi-phase electric machine according to the set angle,
wherein the multi-phase electric machine comprises a plurality of winding systems electrically isolated from one another, each winding system of the plurality of winding systems having windings for a plurality of, in particular three, electrical phases,
wherein detecting the short circuit between turns comprises detecting in which winding system of the plurality of winding systems the short circuit between turns has occurred, and
wherein controlling the multi-phase electric machine comprises controlling the winding system with the short circuit between turns according to the set angle.

31. The non-transitory computer-readable storage medium of claim 30, wherein the angle is set in a predetermined range from 30° to 85°.

32. The non-transitory computer-readable storage medium of claim 31, wherein the predetermined range is from 40° to 80°.

33. (canceled)

34. The non-transitory computer-readable storage medium of claim 30, wherein the angle is set based on electrical currents of winding systems of the plurality of winding systems in which the short circuit between turns has not occurred.

35. The non-transitory computer-readable storage medium of claim 30, wherein the at least one parameter describing the short circuit between turns comprises a location of the short circuit between turns within the winding.

36. A method for controlling a multi-phase electric machine with a stator and a rotor, the method comprising:
detecting a short circuit between turns of a winding of the multi-phase electric machine and at least one parameter describing the short circuit between turns;
setting an angle of a current vector to the positive q axis in the dq coordinate system of the rotor with a negative d portion and a q portion different than zero based on the at least one parameter describing the short circuit between turns;
controlling the multi-phase electric machine according to the set angle; and
determining, by at least one sensor, a characteristic of the short circuit between turns.
